(19) United States
(12) Patent Application Publication
(10) Pub. No.: US 2009/0173606 A1
(43) Pub. Date: Jul. 9, 2009

(54) Keyboard

(75) Inventors: Chi-Cheng Liao, Taipei (TW); Fu-Ming Chen, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/331,660

(22) Filed: Dec. 10, 2008

(30) Foreign Application Priority Data
Jan. 9, 2008 (TW) 97100871

(51) Int. Cl. H01H 13/83; G01D 11/28

(52) U.S. Cl. 200/310; 362/29

(57) ABSTRACT

A keyboard includes a printed circuit board, a light guide sheet, a keypad member and a light shield. The printed circuit board has a plurality of light-emitting devices. The light guide sheet is disposed over the printed circuit board to receive the light output from the light-emitting devices. The keypad member has a plurality of keys, wherein the light guide sheet is disposed between the printed circuit board and the keypad member. The light shield is disposed between the light guide sheet and the keypad member. The light shield has a light-absorbing surface, a light-reflective surface and a plurality of light-outlet holes. The light-reflective surface faces the light guide sheet. The light-absorbing surface faces the keypad member. The light output from the light-emitting devices passes the light-outlet holes to illuminate the keypad member.

### RELATED APPLICATIONS

This application claims priority to Taiwan Application Serial Number 97100871, filed Jan. 9, 2008, which are herein incorporated by reference.

### BACKGROUND

1. Field of Invention

The present invention relates to a keyboard device.

2. Description of Related Art

Several portable electronic devices (such as mobile phones) have backlit keyboards with illuminated keys of single or multiple colors, by which information can be input under dim ambient light circumstances.

In normal case, each key of the backlit keyboards is backlit by one light-emitting device in order to make each key to be illuminated uniformly. When the backlit keyboard has too many keys thereon, multiple keys of the backlit keyboards are backlit by one light-emitting device in order to save cost. However, each key on the backlit keyboard is hence not illuminated uniformly. For the forgoing reasons, there is a need for improving conventional backlit keyboards.

### SUMMARY

It is therefore an objective of the present invention to provide a keyboard device.

In accordance with the foregoing and other objectives of the present invention, a keyboard includes a printed circuit board, a light guide sheet, a keypad member and a light shield. The printed circuit board has a plurality of light-emitting devices. The light guide sheet is disposed over the printed circuit board to receive the light output from the light-emitting devices. The keypad member has a plurality of keys, wherein the light guide sheet is disposed between the printed circuit board and the keypad member. The light shield is disposed between the light guide sheet and the keypad member. The light shield has a light-absorbing surface, a light-reflective surface and a plurality of light-outlet holes. The light-reflective surface faces the light guide sheet. The light-absorbing surface faces the keypad member. The light output from the light-emitting devices passes the light-outlet holes to illuminate the keypad member.

Thus, the present invention provides a light-emitting keyboard device, which has a light guide sheet covered by a light shield on one or two sides thereof, to keep light within the light guide sheet so as to improve light distribution uniformity.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A illustrates a cross-sectional view of a keyboard according to one preferred embodiment of this invention;

FIG. 1B illustrates a cross-sectional view of a keyboard according to another preferred embodiment of this invention;

FIG. 2 illustrates a keypad member and a light shield of a keyboard according to one preferred embodiment of this invention; and

FIG. 3 illustrates a keypad member and a light shield of a keyboard according to another preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

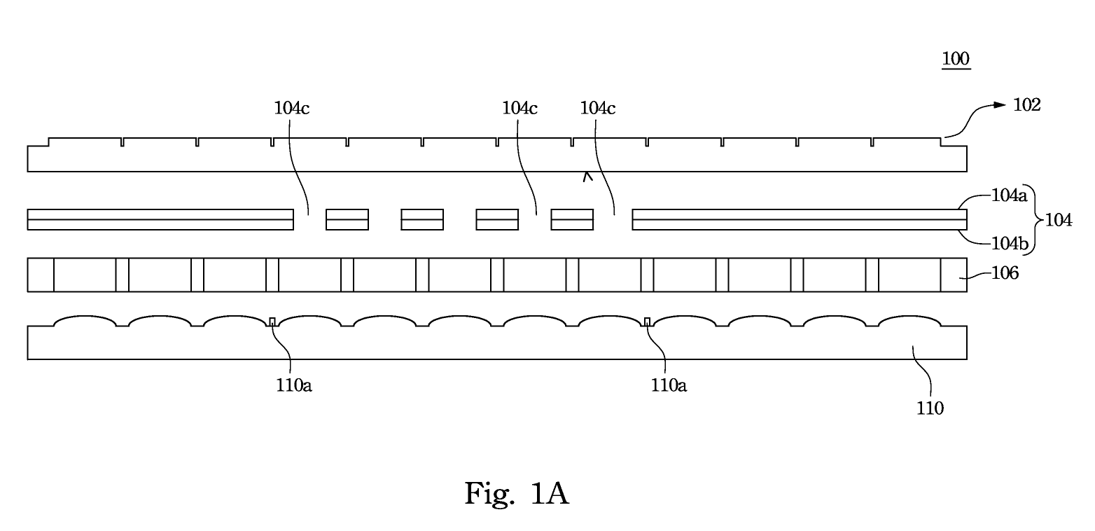

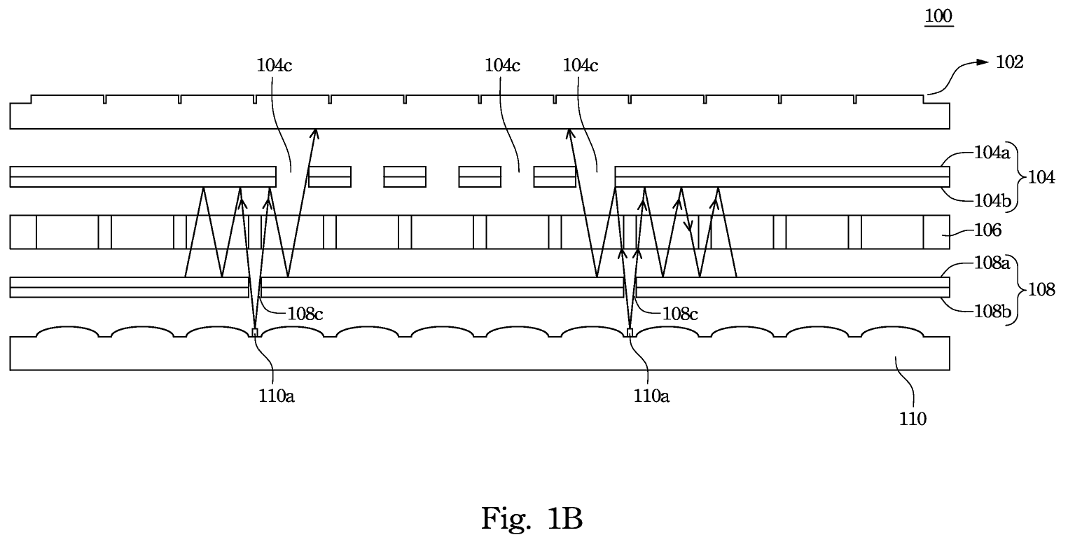

Referring to FIG. 1A and 1B, which respectively illustrate two cross-sectional views of a keyboard according to two preferred embodiments of this invention. A keyboard device 100 can be an input device for a notebook computer, a mobile phone or the other electronic devices. The keyboard device 100 includes a printed circuit board 110, a light guide sheet 106 and a transparent keypad member 102 (having a plurality of keys), which are substantially in parallel with each other. The light guide sheet 106 is positioned between the printed circuit board 110 and the keypad member 102. The printed circuit board 110 has several light-emitting devices 110a on a surface thereof, which faces the light guide sheet 106, so as to illuminate the keypad member 102. In this embodiment, the light-emitting devices 110a can be arc lamps or light-emitting diodes. In order to enable keys on the keypad member 102 to be illuminated uniformly, a light shield is added in the keyboard device 100.

In one embodiment (referring to FIG. 1A), a light shield 104 is located between the keypad member 102 and the light guide sheet 106. The light shield 104 is substantially in parallel with the keypad member 102 and the light guide sheet 106. The light shield 104 has a light-absorbing surface 104a (such as a black light-absorbing surface), which faces the keypad member 102, and a light-reflective surface 104b (such as a white light-reflective surface), which faces the light guide sheet 106. The light shield 104 may have its light-absorbing surface 104a in contact with the keypad member 102, or the light shield 104 may have its light-reflective surface 104b in contact with the light guide sheet 106. The light shield 104 also has multiple light-outlet holes 104c allowing light to be passed through to illuminate corresponding keys on the keypad member 102.

In another embodiment (referring to FIG. 1B), the light shield 104 is located between the keypad member 102 and the light guide sheet 106. The light shield 108 is located between the printed circuit board 110 and the light guide sheet 106. The light shield 104 and the light shield 108 are substantially in parallel with the keypad member 102, the printed circuit board 110 and the light guide sheet 106. The light shield 104 has a light-absorbing surface 104a (such as a black light-absorbing surface), which faces the keypad member 102 and a light-reflective surface 104b (such as a white light-reflective surface), which faces the light guide sheet 106. The light shield 104 may have its light-absorbing surface 104a in contact with the keypad member 102, or the light shield 104 may have its light-reflective surface 104b in contact with the light guide sheet 106. The light shield 108 has a light-absorbing surface 108b (such as a black light-absorbing surface), which faces the printed circuit board 110 and a light-reflective surface 108a (such as a white light-reflective surface), which faces the light guide sheet 106. The light shield 108 may have its light-absorbing surface 108b in contact with the printed circuit board 110, or the light shield 108 may have its light-reflective surface 108a in contact with the light guide sheet 106. The light shield 104 has multiple light-outlet holes 104c allowing light to be passed through to illuminate corresponding keys on the keypad member 102. In addition, the light shield 108 has multiple light-inlet holes 108c allowing light to be passed through and into the light guide sheet 106. The light-inlet holes 108c are substantially aligned with the light-emitting devices 110a in position on the printed circuit board 110. In this embodiment, even if the light-outlet holes 108c are of great number than the light-inlet holes 104c, each of the light-outlet holes 108c still allows substantially the same amount of light to be passed.

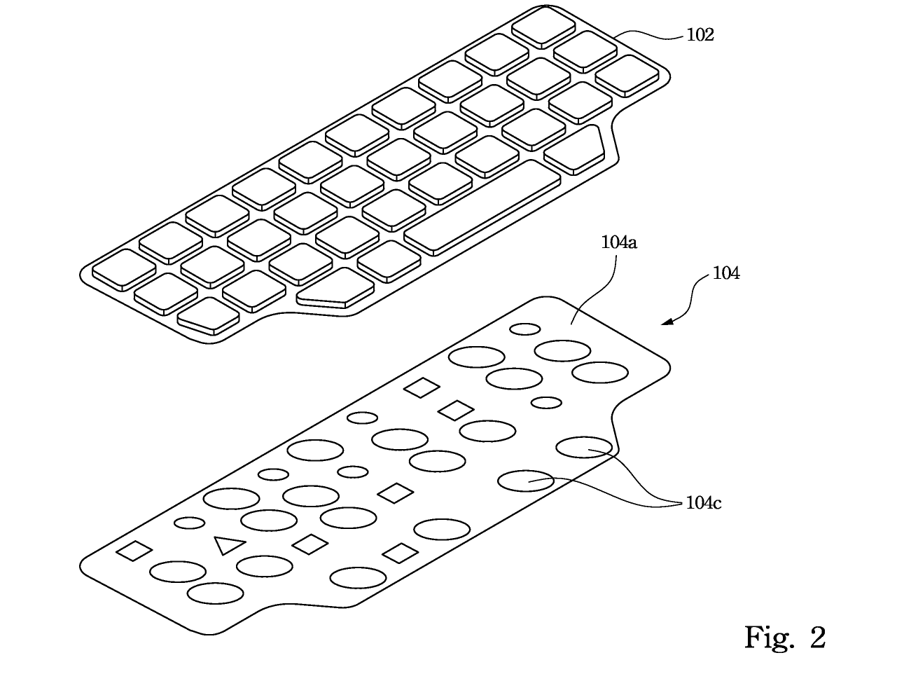

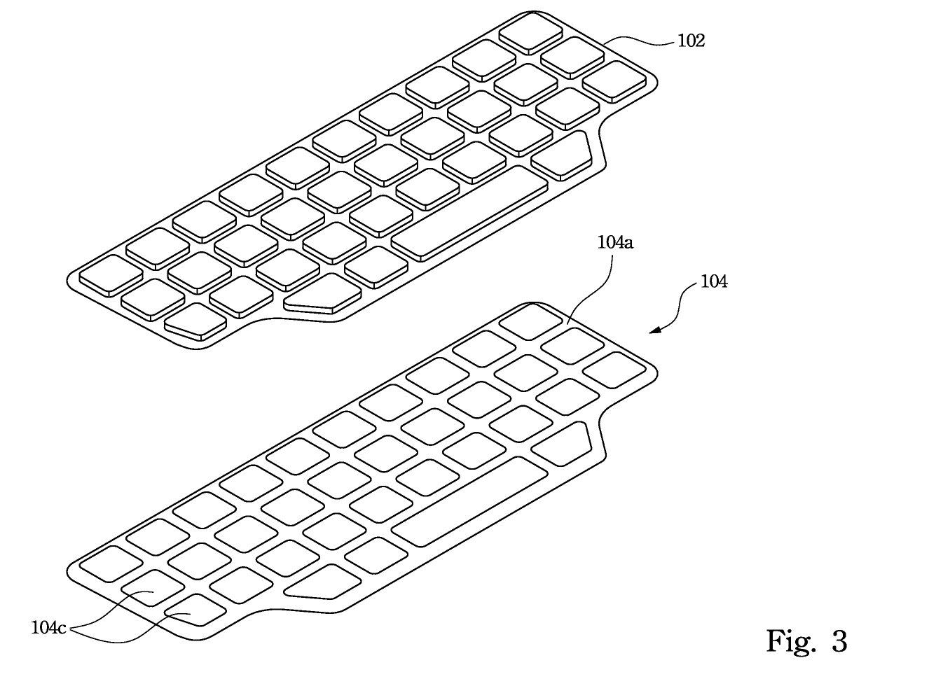

FIG. 2 illustrates a keypad member and a light shield of a keyboard according to one preferred embodiment of this invention. The light-outlet holes 104c on the light shield 104 can be optimized to have various shapes or sizes, i.e. circular or rectangular, larger or smaller, so as to achieve light distribution uniformity. As illustrated in FIG. 3, the light-outlet holes 104c on the light shield 104 are of substantially same shapes and sizes as corresponding keys on the keypad member 102. When the keypad member 102 is assembled with the light shield 104, each light-outlet hole 104c is aligned with each corresponding key on the keypad member 102.

According to discussed embodiments, the present invention provides a light-emitting keyboard device, which has a light guide sheet covered by a light shield on one or two sides thereof, to keep light within the light guide sheet so as to improve light distribution uniformity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A keyboard, comprising:
a printed circuit board having a plurality of light-emitting devices;
a light guide sheet disposed over the printed circuit board to receive the light output from the light-emitting devices;
a keypad member having a plurality of keys, wherein the light guide sheet is disposed between the printed circuit board and the keypad member; and
a light shield disposed between the light guide sheet and the keypad member, the light shield having a light-absorbing surface, a light-reflective surface and a plurality of light-outlet holes, the light-absorbing surface facing the keypad member, the light-reflective surface facing the light guide sheet, the light output from the light-emitting devices passing the light-outlet holes to illuminate the keypad member.

2. The keyboard of claim 1, wherein the light-emitting devices are arc lamps or light-emitting diodes.

3. The keyboard of claim 1, wherein each of the light-outlet holes is aligned with each corresponding key in position.

4. The keyboard of claim 1, wherein each of the light-outlet holes is of a unique size compared with the other.

5. The keyboard of claim 1, wherein the light-reflective surface is in contact with the light guide sheet.

6. The keyboard of claim 1, wherein the light-absorbing surface is in contact with the keypad member.

7. The keyboard of claim 1, wherein the light-absorbing surface is of black color.

8. The keyboard of claim 1, wherein the light-reflective surface is of white color.

9. The keyboard of claim 1, further comprising another light shield disposed between the light guide sheet and the printed circuit board, the light shield having a light-absorbing surface, a light-reflective surface and a plurality of light-inlet holes, the light-absorbing surface facing the printed circuit board, the light-reflective surface facing the light guide sheet, the light output from the light-emitting devices passing the light-inlet holes into the light guide sheet.

10. The keyboard of claim 9, wherein the light-reflective surface is in contact with the light guide sheet.

11. The keyboard of claim 9, wherein the light-absorbing surface is in contact with the printed circuit board.

12. The keyboard of claim 9, wherein the light-absorbing surface is of black color.

13. The keyboard of claim 9, wherein the light-reflective surface is of white color.

14. The keyboard of claim 9, wherein the light-outlet holes are of greater number than the light-inlet holes.
